(19) United States
(12) Patent Application Publication
(10) Pub. No.: US 2022/0014306 A1
(43) Pub. Date: Jan. 13, 2022

(54) METHOD AND DEVICE FOR TRANSMITTING DATA

(71) Applicant: Robert Bosch GmbH, Stuttgart (DE)

(72) Inventors: Andreas Mueller, Waiblingen (DE); Johannes Von Hoyningen-Huene, Kiel (DE)

(21) Appl. No.: 17/372,586

(22) Filed: Jul. 12, 2021

(30) Foreign Application Priority Data
Jul. 10, 2020 (DE) 102020208664.8

(51) Int. Cl. H04L 1/00; H04L 12/863

(52) U.S. Cl. CPC H04L 1/0019; H04L 47/54

(57) ABSTRACT

Methods and devices for transmitting data via a transmission medium. One example method includes ascertaining a probability of at least one transmission error during a future data transmission, and determining, based on the probability, whether the future data transmission should be at least temporarily suspended.

### BACKGROUND OF THE INVENTION

The disclosure relates to a method for transmitting data.

The disclosure also relates to a device for transmitting data.

### SUMMARY OF THE INVENTION

Exemplary embodiments relate to a method for transmitting data via a transmission medium, comprising: ascertaining the probability of at least one transmission error during a future data transmission, and determining, based on the probability, whether the future data transmission should be at least temporarily suspended. This enables in exemplary embodiments, for example, the avoidance at least for part of the time of at least some data transmissions in which a transmission error is likely.

In other exemplary embodiments, it is provided that the method also comprises: a) if the outcome of the determination is that the future data transmission should be at least temporarily suspended, suspending the future data transmission for a specifiable period of time, and/or b) if the outcome of the determination is that the future data transmission should not be suspended, executing the future data transmission.

In other exemplary embodiments, it is provided that ascertaining the probability of at least one transmission error in a future data transmission comprises at least one of the following elements: a) evaluating contextual information, wherein in particular the contextual information indicates, for example, a temporary degradation of the future data transmission, b) evaluating current knowledge regarding existing communication characteristics associated with data transmission via the transmission medium.

In the case of other examples, it is provided that the contextual information is evaluated, for example, if, in particular, a device executing the method according to exemplary embodiments, which according to other exemplary embodiments may also be a control system, has knowledge of a position of an object which is currently moving in the range of the transmission medium, e.g. which moves through a communication line (e.g. between transmitter and receiver) in the case of a wireless communication, at least in some regions, by means of the transmission medium.

In other exemplary embodiments, this contextual information can be obtained, for example, in particular directly, because it may already be present in a device executing the method according to exemplary embodiments. For example, in other exemplary embodiments the position of an object may already be known as a parameter or variable quantity in the device or control system, and, if appropriate, can therefore be used as part of the contextual information.

In other exemplary embodiments, the contextual information can be determined, for example, by an additional device and transmitted to the device executing the method according to exemplary embodiments.

In other exemplary embodiments, the evaluation of current knowledge regarding existing communication characteristics associated with data transmissions via the transmission medium may comprise the following, for example: in the case of earlier packet errors in a first communication direction (e.g. the uplink (UL) direction), e.g. in a preceding communication cycle, it can be concluded, for example on account of the reciprocity in time-division duplex (TDD)-based systems, that a probability of transmission errors in a second communication direction opposite to the first communication direction (e.g. the downlink (DL) direction) is also increased.

In other exemplary embodiments, it is provided that the determination of whether the future data transmission should be at least temporarily suspended is also based on a maximum number of permissible, in particular consecutive, data transmission failures. Therefore, in other exemplary embodiments, both the maximum number of permissible, in particular consecutive, data transmission failures and the calculated probability can be considered.

In other exemplary embodiments, it will be determined that the future data transmission should be at least temporarily suspended if the probability of at least one transmission error during the future data transmission exceeds a specifiable limit value, wherein the specifiable limit value can be 10 percent, for example.

In other exemplary embodiments, it is provided that the suspension comprises: releasing communication resources allocated for the future data transmission, and optionally, using the released communication resources for another data transmission. This allows the communication resources allocated for the future data transmission to be used elsewhere, wherein in other exemplary embodiments, the other data transmission may, for example, have a greater probability of success than the suspended data transmission.

In other exemplary embodiments, it is provided that the data is transmitted cyclically via the transmission medium, e.g. in consecutive communication cycles.

In other exemplary embodiments, it is provided that the transmission medium supports wireless and/or wired data transmission. In other exemplary embodiments, it can also be provided that the transmission medium supports wireless data transmission in at least some sections of a first region and in at least some sections of a second region.

Other exemplary embodiments relate to a device for transmitting data, wherein the device is designed for executing the method according to the embodiments.

In other exemplary embodiments, it is provided that the device comprises: a computing device (“computer”) comprising at least one computing core, a storage device assigned to the computing device for at least temporarily storing at least one of the following elements: a) data, b) computer program, in particular for executing a method according to the embodiments.

In other exemplary embodiments, the storage device comprises a volatile memory (e.g. working memory or RAM) and/or a non-volatile memory (e.g. flash EEPROM).

In other exemplary embodiments, the computing device comprises at least one of the following elements: microprocessor (μP), microcontroller (μC), application-specific integrated circuit (ASIC), system on chip (SoC), programmable logic module (e.g. FPGA, field programmable gate array), hardware circuit, or any combinations thereof.

In other exemplary embodiments, the device comprises a preferably bidirectional data interface (e.g. a transceiver), for sending data via the transmission medium and/or for receiving data from the transmission medium.

Further exemplary embodiments relate to a system comprising a transmission medium and at least one device according to the embodiments.

Further exemplary embodiments relate to a computer-readable storage medium, comprising commands that, when executed by a computer, cause the computer to execute the method according to the embodiments.

Further exemplary embodiments relate to a computer program comprising commands which when the program is executed by a computer, cause the computer to execute the method according to the embodiments.

Further exemplary embodiments relate to a data carrier signal that characterizes and/or transmits the computer program according to the embodiments. For example, the data carrier signal can be received via an optional data interface of the device.

Further exemplary embodiments relate to a use of the method according to the embodiments and/or the device according to the embodiments and/or the system according to the embodiments and/or the computer-readable storage medium according to the embodiments and/or the computer program according to the embodiments and/or the data carrier signal according to the embodiments for at least one of the following elements: a) transmitting data, in particular in a cyclic communication system; b) suspending at least one data transmission based on a probability of success for the at least one data transmission; c) avoiding transmission errors, in particular packet errors; d) rededicating communication resources allocated for a future data transmission; e) real-time communication, for example in industrial automation, e.g. in so-called closed-loop control applications.

Further features, application possibilities and advantages of the invention are derived from the following description of exemplary embodiments of the invention that are shown in the accompanying figures of the drawing. In the description, all the features described or illustrated form the subject matter of the invention either individually or in any combination, independently of their summary in the claims or their cross-reference, and independently of their formulation or illustration in the description or the drawing respectively.

### BRIEF DESCRIPTION OF THE DRAWINGS

In the drawings:

FIG. 1 shows a schematic, simplified block diagram according to exemplary embodiments,

FIG. 2A shows a schematic, simplified flow diagram of methods according to further exemplary embodiments,

FIG. 2B shows a schematic, simplified flow diagram of methods according to further exemplary embodiments,

FIG. 2C shows a schematic, simplified flow diagram of methods according to further exemplary embodiments,

FIG. 2D shows a schematic, simplified flow diagram of methods according to further exemplary embodiments,

FIG. 3 shows a schematic, simplified block diagram according to exemplary embodiments, and

FIG. 4 shows schematic aspects of a use according to further exemplary embodiments.

### DETAILED DESCRIPTION

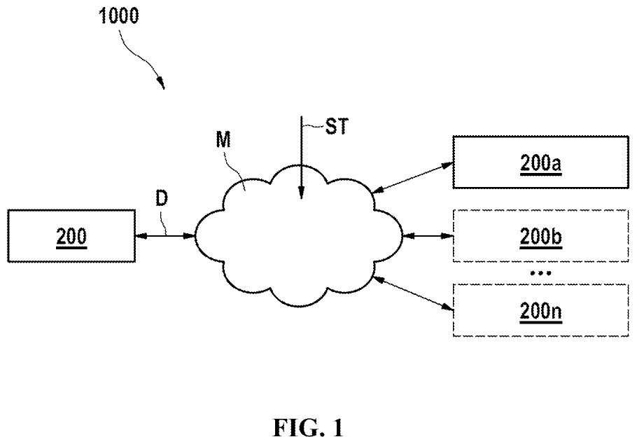

FIG. 1 shows a schematic, simplified block diagram according to exemplary embodiments. The illustration shows a system 1000 comprising a transmission medium M and a plurality of devices 200, 200a, 200b, . . . , 200n, which can exchange data D, e.g. among one another or with other devices not shown, in particular via the transmission medium M. The arrow ST symbolizes sources of interference that can occur in other exemplary embodiments during transmission of data.

In other exemplary embodiments, it is provided that the data D is transmitted cyclically via the transmission medium M, e.g. in consecutive communication cycles.

In other exemplary embodiments, it is provided that the transmission medium M supports wireless and/or wired data transmission. In other exemplary embodiments, it can also be provided that the transmission medium M supports wireless data transmission in at least some sections of a first region and in at least some sections of a second region.

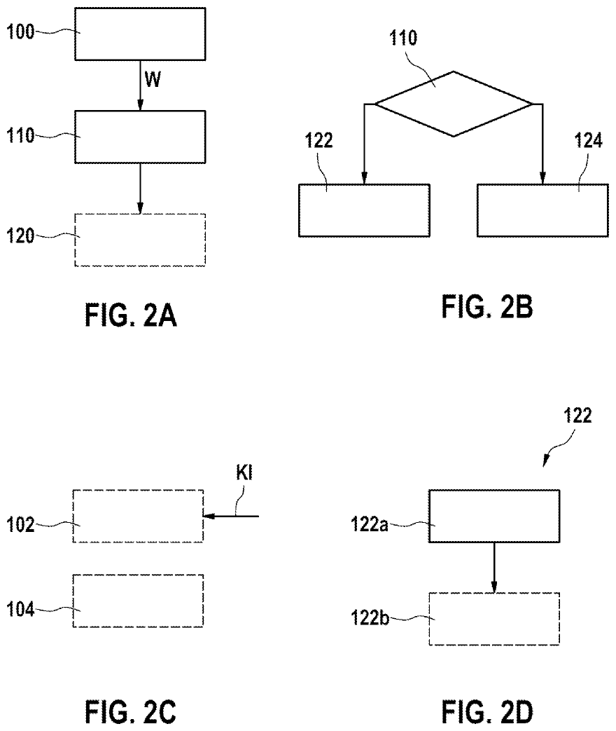

Other exemplary embodiments relate to a method, see FIG. 2A, for transmitting data via a transmission medium M, which method is at least temporarily executable, for example, by at least one of the devices 200, 200a, 200b, . . . , 200n, for example, by the device 200. The method comprises: ascertaining 100 a probability W of at least one transmission error during a future data transmission, determining 110, based on the probability W, whether the future data transmission should be at least temporarily suspended. This enables, in other exemplary embodiments, for example, the avoidance of at least some data transmissions in which a transmission error is likely, at least for part of the time. The optional block 120 symbolizes an operation of a device 200 executing the method based on the determination according to block 110.

In other exemplary embodiments, FIG. 2B, it is provided that the method also comprises: a) if the outcome of the determination 110 is that the future data transmission should be at least temporarily suspended, suspending 122 the future data transmission for a specifiable period of time, and/or b) if the outcome of the determination 110 is that the future data transmission should not be suspended, executing 124 the future data transmission.

In other exemplary embodiments, see FIG. 2C, it is provided that ascertaining 100 (FIG. 2A) the probability W of at least one transmission error in a future data transmission comprises at least one of the following elements: a) evaluating 102 contextual information KI, wherein in particular the contextual information KI indicates, for example, a temporary degradation of the future data transmission, b) evaluating 104 current knowledge regarding existing communication characteristics associated with data transmissions via the transmission medium.

In other exemplary embodiments it is provided that the evaluation 102 of the contextual information KI takes place, for example, when, in particular, a device 200 (FIG. 1) executing the method according to exemplary embodiments, which device according to other exemplary embodiments can also be a control system, has knowledge of a position of an object (not shown) which is currently moving in the range of the transmission medium, e.g. which in particular in the case of wireless communication, at least in some regions, by means of the transmission medium M moves through a communication line (e.g. between transmitter and receiver, e.g. between the device 200 which at least temporarily functions as a transmitter and the device 200a which at least temporarily functions as a receiver).

In other exemplary embodiments, the contextual information KI can be obtained in particular directly, for example, because it may already be present in a device 200 executing the method according to exemplary embodiments. For example, in other exemplary embodiments, the position of an object may already be known as a parameter or variable quantity in the device 200 or control system, and may therefore be used as (part of) the contextual information.

In other exemplary embodiments, the contextual information KI can be determined e.g. by a further device (not shown) and transmitted to the device 200 executing the method according to exemplary embodiments.

In other exemplary embodiments, the evaluation 104 (FIG. 2C) of current knowledge regarding existing communication characteristics associated with data transmissions via the transmission medium M may comprise the following, for example: in the case of earlier transmission errors, e.g. packet errors, according to other exemplary embodiments with a packet-oriented data transmission, in a first communication direction (e.g. the uplink (UL) direction), e.g. in a preceding communication cycle, it can be concluded, for example on account of the reciprocity in time-division duplex (TDD)-based systems 1000, that a probability of transmission errors in a second communication direction opposite to the first communication direction (e.g. the downlink (DL) direction) is also increased.

In other exemplary embodiments, it is provided that the determination 110 (FIG. 2A) of whether the future data transmission should be at least temporarily suspended is also based on a maximum number of permissible, in particular consecutive, data transmission failures. Therefore, in other exemplary embodiments, both the maximum number of permissible, in particular consecutive, data transmission failures and the calculated probability W can be considered.

In other exemplary embodiments, it will be determined, cf. step 110 from FIG. 2A, that the future data transmission should be at least temporarily suspended, cf. step 122 from FIG. 2B, if the probability W of at least one transmission error during the future data transmission exceeds a specifiable limit value, wherein the specifiable limit value can be 10 percent, for example.

In other exemplary embodiments, see FIG. 2D, it is provided that the suspension 120 comprises: releasing 122a communication resources allocated for the future data transmission, and optionally, using 122b the released communication resources for another data transmission. This allows the communication resources allocated for the future data transmission to be used elsewhere, wherein in other exemplary embodiments, the other data transmission may, for example, have a greater probability of success than the suspended data transmission.

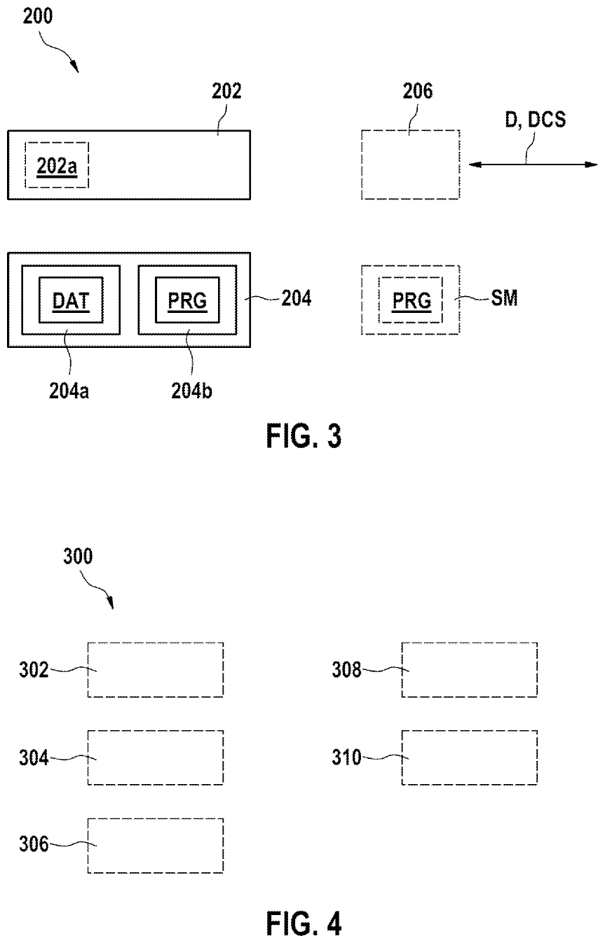

Further exemplary embodiments relate to a device 200 for transmitting data D, wherein the device 200 is designed for executing the method according to the embodiments. FIG. 3 shows a schematic configuration of the device 200 according to other exemplary embodiments.

The device 300 comprises a computing device (“computer”) comprising at least one computing core 202a, a storage device 204 assigned to the computing device 202 for at least temporarily storing at least one of the following elements: a) data DAT, b) computer program PRG, in particular for executing a method according to the embodiments. In other exemplary embodiments, the data can comprise e.g. the determined probability W, cf. step 100 from FIG. 2A, and/or data D to be transmitted via the transmission medium and/or received via the transmission medium in the future.

In other exemplary embodiments, the storage device 204 comprises a volatile memory 204a (e.g. working memory or RAM) and/or a non-volatile memory 204b (e.g. flash EEPROM).

In other exemplary embodiments, the computing device 202 comprises at least one of the following elements: microprocessor (μP), microcontroller (μC), application-specific integrated circuit (ASIC), system on chip (SoC), programmable logic module (e.g. FPGA, field programmable gate array), hardware circuit, or any combinations thereof.

In other exemplary embodiments, the device 200 comprises a preferably bidirectional data interface 206 (e.g. a transceiver), for sending data D via the transmission medium M and/or for receiving data D from the transmission medium M.

Other exemplary embodiments relate to a computer-readable storage medium SM comprising commands PRG, which when executed by a computer 202 cause the computer to execute the method according to the embodiments.

Further exemplary embodiments relate to a computer program PRG comprising commands which when the program PRG is executed by a computer 202, cause the computer to execute the method according to the embodiments.

Further exemplary embodiments relate to a data carrier signal DCS that characterizes and/or transmits the computer program PRG according to the embodiments. For example, the data carrier signal DCS can be received via the optional data interface 206 of the device 200.

Further exemplary embodiments relate to a system 1000 (FIG. 1) comprising a transmission medium M and at least one device 200, 200a, 200b, . . . , 200n according to the embodiments.

Further exemplary embodiments, see FIG. 4, relate to a use 300 of the method according to the embodiments and/or the device 200, 200a, 200b, . . . , 200n according to the embodiments and/or the system 1000 according to the embodiments and/or the computer-readable storage medium SM according to the embodiments and/or the computer program PRG according to the embodiments and/or the data carrier signal DCS according to the embodiments for at least one of the following elements: a) transmitting 302 data D, in particular in a cyclic communication system; b) suspending 304 at least one data transmission based on a probability of success for the at least one data transmission; c) avoiding 306 transmission errors, in particular packet errors; d) rededicating 308 communication resources allocated for a future data transmission; e) real-time communication 310, for example in industrial automation.

Further exemplary embodiments are described below, each of which can be used individually or in combination with at least one of the above-described exemplary embodiments.

In other exemplary embodiments, individual transmission errors, e.g. in the communication layer of the device 200 (FIG. 1), do not necessarily lead to an immediate error state in an application layer located above the communication layer. Even if there are many ways to avoid package errors as far as possible in other exemplary embodiments, they cannot be prevented in all cases. However, in other exemplary embodiments scenarios are conceivable in which increased error probabilities can be estimated in advance. If, for example, it is foreseeable that a future data transmission (“transmission attempt”) has a high probability of being unsuccessful, in other exemplary embodiments it could be suspended and the freed resources could be transferred to other services, for example, that have a lower probability of error.

In other exemplary embodiments, the device 200 according to FIG. 1 is an, in particular central, control unit or a control system which communicates with at least one other network node 200a, 200b, . . . , 200n via the faulty transmission medium M, wherein e.g. a bidirectional communication is possible.

For example, in the system 1000, the required transmission resources are reserved for real-time data traffic in at least some communication cycles, for example every communication cycle. In addition to time-critical data and possibly signaling data, it may also be possible to transfer other, e.g. non-time-critical data.

In other exemplary embodiments, during a configuration phase the required communication resources are reserved for at least one time-critical application. For each subscriber 200, 200a, . . . , the required packet lengths and communication cycle times are allocated in such a way that specifiable time limits or deadlines are reached or adhered to.

In other exemplary embodiments, additional communication resources may also be allocated or kept in reserve if necessary in order to increase reliability, for example in the case of a packet error in the next communication cycle.

In other exemplary embodiments, the following steps are carried out, for example during real-time operation which follows the configuration phase, for example, preferably in each communication cycle:

1. The control system 200 checks whether the data packets in the preceding cycles were transferred without errors in the same transmission direction or whether critical multiple errors are imminent.

2. In other exemplary embodiments the control system 200 ascertains whether the probability of transmission errors in the current communication cycle is significantly increased. Possible bases for such a decision include, but not exclusively, the contextual information KI (FIG. 2C) described above and/or the current knowledge, cf. also step 104 from FIG. 2C.

3. In other exemplary embodiments, the control system 200 decides when or whether a planned cyclic transmission to a subscriber 200a will be suspended, see also step 122 from FIG. 2B. The transmission in other exemplary embodiments can only be suspended if the following conditions are met:

a. The suspension 122 of the transmission in the current communication cycle must not cause the number of permitted sequential packet losses to be exceeded.

b. The probability W of a transmission error in the current communication cycle is significantly increased (e.g. >10%).

4. Depending on the decision in the preceding section 3, in other exemplary embodiments the control system 200 either transmits the data to subscriber 200a as originally planned (see also step 124 of FIG. 2B), or suspends this planned transmission for a communication cycle and releases the communication resources. In other exemplary embodiments the communication resources are then used for transmission to another subscriber 200b, which has a different, ideally lower probability of error with regard to data transmissions to it, for example, because it is located in another location. In particular, in other exemplary embodiments, subscribers that were previously affected by packet errors can also be preferred here, thereby reducing the probability of critical multiple errors in other exemplary embodiments.

5. In other exemplary embodiments the originally scheduled subscriber 200a checks whether the expected data was transmitted by the control system 200. If the transmission has been temporarily suspended by the control system 200, in other exemplary embodiments this subscriber can detect this. In this case, in other exemplary embodiments the expected packet is treated as containing errors, i.e. an error counter is incremented and the application layer is informed that no current data is available.

In other exemplary embodiments, it is assumed that two transmission errors can be tolerated and that only the third error leads to a failure or an emergency stoppage of an application, which is based, for example, on the data communication via the transmission medium M.

In cycle N, in other exemplary embodiments the control system 200 expects little prospect of a successful transmission. Since, e.g., the previous transmission was successful and therefore no multiple errors are imminent, in other exemplary embodiments the transmission is waived (suspension 122), and the resources are released, for example, for another application or another subscriber.

In cycle N+1, in other exemplary embodiments the control system 200 may continue to expect little prospect of a successful transmission. However, since the previous waiver or suspension 122 of the transmission then makes multiple errors more likely, in further exemplary embodiments the current transmission will be carried out as originally planned for cycle N+1. If the transmission in cycle N+1 is successful, in other exemplary embodiments the transmission could be suspended again in the following cycle N+2. However, if the transmission in cycle N+1 is unsuccessful again, according to other exemplary embodiments additional communication resources possibly provided or reserved for this purpose may be mobilized in cycle N+2 in order nevertheless to ensure a successful transmission and, in particular, to avoid multiple errors (in this example, three sequential errors).

In other exemplary embodiments, it is also conceivable that in the event of an error, measures are initiated, for example, to correct the error or to avoid future errors, for example, ones which require longer than one communication cycle in order to become active. Since in the following communication cycles an increased probability of error can therefore be assumed, in other exemplary embodiments the transmission could also be automatically suspended in such cases. This is illustrated in the following example:

in cycle N, in other exemplary embodiments a transmission error occurs. The control system 200 then initiates measures which in future will lead to a more robust transmission, but which may only become active or effective from the next but one communication cycle N+2. In cycle N+1, in other example embodiments the control system assumes an increased probability of error in the current cycle due to the previous error. The transmission is immediately suspended in this cycle in other exemplary embodiments, and the communication resources are transferred to other services or used for other transmissions. If, in other example embodiments, a time-critical application tolerates e.g. two erroneous cycles in sequence, from the application point of view this is not a problem as yet. In cycle N+2, in other exemplary embodiments the additional measures to increase the robustness of the transmission are activated, so that from now on a lower probability of error can (again) be assumed.

Other exemplary embodiments enable communication systems 1000, which on the one hand have a predictable, increased probability for packet errors and on the other hand tolerate individual packet losses, to spontaneously release fixed allocated communication resources, at least temporarily, and use them for other purposes. As an end result of the principle according to the embodiments, more communication resources are made available to other applications or services, whereas, for example, a time-critical application for which the communication resources are actually allocated barely suffers any negative effect. In other exemplary embodiments, communication resources are only released, for example, if the successful transfer has a reduced prospect of success in any case.

1. A method for transmitting data (D) via a transmission medium (M), the method comprising:
ascertaining (100) a probability (W) of at least one transmission error during a future data transmission, and
determining (110), based on the probability (W), whether the future data transmission should be at least temporarily suspended.

2. The method according to claim 1, further comprising: a) if the outcome of the determination (110) is that the future data transmission should be at least temporarily suspended, suspending (122) the future data transmission for a specifiable time period, and/or b) if the outcome of the determination (110) is that the future data transmission should not be suspended, executing (124) the future data transmission.

3. The method according to claim 1, wherein ascertaining (100) the probability (W) of at least one transmission error in a future data transmission comprises at least one of the following elements: a) evaluating (102) contextual information, wherein in particular the contextual information indicates, for example, a temporary degradation of the future data transmission; b) evaluating (104) current knowledge regarding existing communication characteristics associated with data transmission via the transmission medium (M).

4. The method according to claim 1, wherein the determination (110) of whether the future data transmission should be at least temporarily suspended is also carried out based on a maximum number of permissible, in particular consecutive, failures of data transmissions.

5. The method according to claim 1, wherein it is determined (110) that the future data transmission should be at least temporarily suspended when the probability (W) of at least one transmission error in the future data transmission exceeds a specifiable limit value.

6. The method according to claim 2, wherein the suspension (122) comprises: releasing (122a) communication resources allocated for the future data transmission, and using (122b) the released communication resources for another data transmission.

7. The method according to claim 1, wherein the data is transmitted cyclically via the transmission medium (M).

8. The method according to claim 1, wherein the transmission medium (M) allows a wireless and/or a wired data transmission.

9. A device (200, 200a, 200b, . . . , 200n) for transmitting data (D), wherein the device (200, 200a, 200b, . . . , 200n) is configured to
ascertaining (100) a probability (W) of at least one transmission error during a future data transmission, and
determining (110), based on the probability (W), whether the future data transmission should be at least temporarily suspended.

10. A system (1000) comprising a transmission medium (M) and at least one device (200, 200a, 200b, . . . , 200n), wherein the device is configured to
ascertain (100) a probability (W) of at least one transmission error during a future data transmission, and
determine (110), based on the probability (W), whether the future data transmission should be at least temporarily suspended.

11. A computer-readable storage medium (SM), comprising commands (PRG) which when executed by a computer (202), cause said computer to
ascertain (100) a probability (W) of at least one transmission error during a future data transmission, and
determine (110), based on the probability (W), whether the future data transmission should be at least temporarily suspended.
